(19) United States
(12) Patent Application Publication
(10) Pub. No.: US 2012/0118680 A1
(43) Pub. Date: May 17, 2012

(54) WHEEL CHOCK ASSEMBLY

(76) Inventor: Denis Giglio, Bayport, NY (US)

(21) Appl. No.: 12/947,807

(22) Filed: Nov. 16, 2010

(51) Int. Cl. B60T 3/00; B60R 99/00

(52) U.S. Cl. 188/32; 280/762

(57) ABSTRACT

A wheel chock assembly is described that includes a wheel chock, a tether and an attachment device. The tether connects the wheel chock and attachment device. The wheel chock is positionable on a ground surface and against a wheel of a vehicle to block the wheel of the vehicle from rolling in a first direction. The attachment device connects to the vehicle body or chassis. When the vehicle moves in a second direction away from the wheel chock, the wheel chock is pulled beside the vehicle. The user can then stop the vehicle and remove the attachment device from the vehicle and store wheel chock assembly in a desired location in the vehicle. A method of using a wheel chock assembly includes providing a wheel chock assembly that includes a wheel chock and an attachment device connected by a tether. The wheel chock is positioned to engage the surface and wheel of the vehicle such that the wheel chock prevents the movement of the vehicle in the first direction. The attachment device is connected to the vehicle. The tether retains the connection between the attachment device and wheel chock. When the vehicle is moved in a second direction away from the wheel chock, the wheel disengages from the wheel chock. The attachment device and tether pull the wheel chock with the vehicle as it moves in the second direction.

### BACKGROUND OF THE INVENTION

1. Field of the Invention

The present disclosure relates to wheel chocks used to restrict the movement of wheeled vehicles and in particular to a wheel chock assembly that blocks the movement of the vehicle in a first direction, connects to the vehicle and the connection of the wheel chock to the vehicle removes the wheel chock from the blocked position with the movement of the vehicle in a second direction opposed to the first direction.

2. Description of the Related Art

Wheel chocks have the ability to provide an invaluable safety device for wheeled vehicles. The added measure of safety of wheel chocks, however, is often ignored which leads to unnecessary accidents. In many instances these accidents are associated with parking brake and/or transmission failures of the vehicle during the maintenance, repair or launching of a boat from a trailer or retrieving a boat to a trailer. These accidents can be readily prevented through the use of wheel chocks that block the undesired movement of the vehicle.

A contributing element to the lack of employing wheel chocks is the complexity and/or specialized nature of the connection of the some commercial chock devices and the safe removal of the chock from its installed position. The user of wheel chocks is always concerned for the period between the removal of the wheel chock and movement of the vehicle from its previously chocked position. One wheel chock device requires hooking a flexible line connected to a pair of chocks onto a hitch on the back of the vehicle. This latter device requires the hooking the flexible line to the hitch, a delicate process, which can require a single chock installer to undesirably stand down slope and behind the vehicle or an additional person to thread the flexible line between the hitch and vehicle. These connections detract from the flexibility and can make the application of these chock devices less than desirable.

A wheel chock assembly is needed that can be readily connected to a wheeled vehicle, engage one of the wheels of the vehicle to block the movement of the vehicle in one direction and the connection of the chock assembly to the wheeled vehicle retains the chock assembly to the vehicle during movement such that the wheel chock is pulled beside the vehicle.

### SUMMARY OF THE INVENTION

A wheel chock assembly is described that comprises a wheel chock, a tether and an attachment device. The wheel chock has an inclined ramp side and an opposed backside, a base that connects to the backside and the ramp side. Two opposing sides connect to the ramp, backside and base. The ramp side is adapted to interface with an outer circumference or tread portion of a tire of a vehicle in proximity to a surface in contact with the tire. The attachment device is adapted to connect to any portion of the vehicle. This can include any part of the body or frame of the vehicle. The tether includes a first end portion that connects to the wheel chock and an opposed second end portion that connects to the attachment device.

The tether is preferably a flexible elongate segment of rope, wire and/or chain, for example. The tether can alternatively have a structure such that the tether when positioned between the attachment device and wheel chock biases the engagement of the wheel chock between the surface and the wheel or tire of the vehicle. The tether can also be rigid and provide a controlled degree of resistance to the wheel chock being deflected or moved when the wheel chock is engaged between the wheel and the surface and the opposing end of the tether is connected to the attachment device. The rigid tether can also be adjustable in length.

The attachment device connects to the vehicle. The attachment device can include a magnet that connects to the vehicle. The attachment device can also include a housing that receives and connects to the magnet. The magnet defines a face that extends from the housing that can interface with an external magnetic source such as the vehicle. A layer or coating can be positioned on at least the face of the magnet. The layer does not significantly interrupt the magnetic force of the magnet and provides a surface that does not mar or scratch the vehicle. The attachment device can also take the form of a flexible magnetic sheet similar to those used for signage.

A method of removing a wheel chock from a vehicle on a surface is described. The method comprises providing a wheel chock assembly that includes a wheel chock and an attachment device connected by a tether. The method includes the step of engaging the wheel chock between the surface and a wheel of the vehicle. The wheel chock in this location is positioned for stopping the movement of the wheel in a first direction. The method also includes the step of connecting the attachment device to the vehicle in proximity to the wheel. The method further includes moving the vehicle in a second direction opposing the wheel chock or opposing the first direction and disengaging the wheel from the wheel chock. The method can still further includes the step of pulling the wheel chock with and beside the vehicle by the tether connected to the attachment device.

The step of connecting the attachment device can further include positioning the attachment device and the wheel chock such that the tether is biasing the wheel chock to engage the surface and the wheel. The step of connecting the attachment device can also include connecting the attachment device to the vehicle such that a rigid tether fixes the wheel chock in the position of engaging the surface and the wheel. The step of connecting the attachment device can still further include adjusting the length of the tether to accommodate the distance between the wheel chock and the attachment device.

### BRIEF DESCRIPTION OF THE DRAWINGS

Preferred embodiments of the disclosure are described below with reference to the drawings, wherein like numerals are used to refer to the same or similar elements.

FIG. 1 is a perspective view of a wheel chock assembly that includes a wheel chock, a tether and an attachment device, the wheel chock assembly constructed in accordance with the present disclosure;

FIG. 2 is an operational view the wheel chock assembly of FIG. 1 connected to a side of a vehicle by a magnet of the attachment device, the wheel chock blocking the movement of a wheel of the vehicle in a second direction and the tether connects the wheel chock and attachment device;

FIG. 3 is the operational view of the wheel chock assembly of FIG. 2 connected to the side of the vehicle by a suction cup of the attachment device, the wheel chock blocking the movement of the wheel of the vehicle from movement in the second direction and the tether connects the wheel chock and attachment device; and

FIG. 4 is an operational view of the wheel chock assembly of FIG. 2 connected to the side of the vehicle by a flexible magnetic panel of the attachment device, the wheel chock pulled with the vehicle as the vehicle moves in a first direction, the tether connects the wheel chock and attachment device.

### DETAILED DESCRIPTION OF THE INVENTION

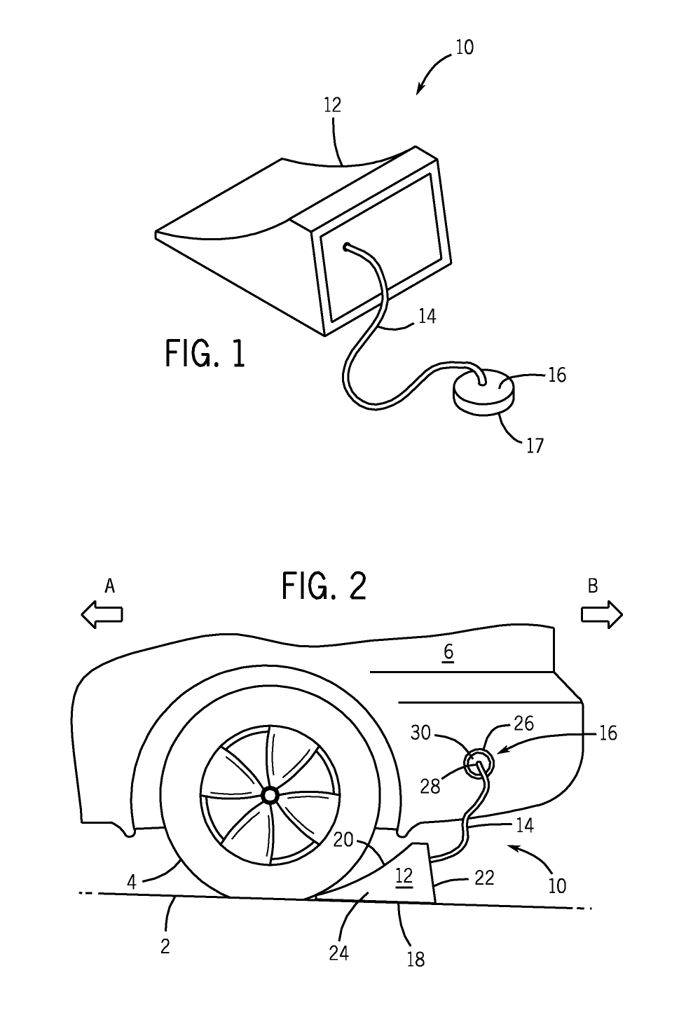

Referring initially to FIG. 1, wheel chock assembly 10 includes a wheel chock 12, a tether 14 and an attachment device 16. Tether 14 connects to chock 12 and attachment device 16. In this preferred embodiment, the first end portion of tether 14 is fastened to chock 12 and an opposing second end portion is fastened to attachment device 16.

Wheel chock 12 is a standard chock assembly 6. Wheel chock 12 has a base or first side 18, an inclined preferably arcuate ramp side 20 and a backside 22 that connects ramp side 20 and base 18. Wheel chock 12 has two opposing sides 24 that connect to base 18, ramp side 20 and backside 22. Wheel chock 12 can be fabricated from any material suitable for use as a wheel chock. This can include select polymers, metals/metal alloys, natural materials such as wood and/or composite materials.

Tether 14 is preferably a flexible line such as a rope, chain or wire that has sufficient strength to pull wheel chock 12. A first end portion of tether 14 connects to wheel chock 12 and a second end portion of tether 14 connects to attachment device 16. Tether 14 can vary in length, but is preferably between approximately three (3) feet and approximately four (4) feet in length.

The first end portion of tether 14 attaches to chock 12. Tether 14 can connect to one or both of sides 24 and/or backside 22 by any manner so as to provide a secure connection. In this one preferred embodiment, the first end portion attaches to backside 22. In another preferred embodiment for example, one of sides 24 defines an aperture, the first end portion of tether 14 is passed through the aperture in side 24 and a knot is tied on the opposing inner side of side 24. The knot precludes the withdrawal of the connection between second end portion 13 and chock 12. Alternatively, the first end portion of tether 14 can connect to wheel chock 12 by any means to include adhesives, heat bonding, a standard mechanical fastener such as clamp, friction or crimp type connector.

As shown in FIGS. 1 and 2, the second end portion of tether 14 attaches to attachment device 16. Tether 14 can connect to attachment device 16 by any manner so as to make a secure connection. The second end portion of tether 14 connects to attachment device 16 using standard means that can include, for example, heat bonding, adhesives and/or fasteners as discussed above. The connection of tether 14 to attachment device 16 and wheel chock 12 accommodates the movement of wheel chock 12 and attachment device 16 relative to tether 14.

Wheel chock 12 is configured to engage with a wheel 4 of a vehicle 6 and attachment device 16 is configured to connect to vehicle 6. Attachment device 16 can include a magnet that magnetically connects to a magnetic portion of vehicle 6 and fixes attachment device 16 in a selected position. Attachment device 16 in this configuration includes a face 17 that connects to vehicle 6. In one preferred embodiment, the magnet of attachment device 16 has an annular shape, but it is understood that the magnet can vary in shape and include multiple connected smaller magnets that can adapt to varying shapes of differently styled vehicular bodies.

The magnet of attachment device 16 can further include a layer 26 that connects to at least the first side 17. Layer 26 can provide one or more of a variety functions such as protection against corrosion, oxidation and/or marring. When attachment device 16 is connected to an external source of magnetism, layer or coating 26 on first side 17 also reduces the likelihood of marring the surface of the external source of magnetism. The preferred material for layer 26 is a poly vinyl chloride (PVC). It is understood, however, that layer 26 can be fabricated of a wide variety of materials to include different polymers, natural materials such as rubber, sealants and other materials and/or coatings. Layer 26 is constructed to protect the magnet of attachment device 16, the interface with the external source of magnetism and/or minimize any loss of magnetic force between magnet 16 and the external source of magnetism.

Attachment device 16 preferably includes a connector 28 that fastens to the second end portion of tether 14. Connector 28 can connect to tether 14 using any of the means as described above, but would preferably use a mechanical or adhesive connection. In one preferred embodiment of attachment device 16, the magnet has an annular shape with a first aperture in face 17 and a second aperture in the obverse side from face 17. The second aperture is smaller than the first aperture such that the second end portion of tether 14 can be positioned through the second aperture and then knotted such that the knotted second end portion of tether 14 cannot be withdrawn through the second aperture. The knotted second end portion of tether 14 is positionable within the larger first aperture defined in the annular shaped magnet of attachment device 16.

Attachment device 16 can also include a housing 30 that connects to the one or more magnets of attachment device 16. For example, housing 30 can vary in configuration from a plate to a cup that receives the magnet of attachment device 16. The magnet connects to housing 30 such that face 17 is positioned external to housing 30 for connecting to an external source of magnetic material such as vehicle 6. Housing 30 can be made of any material, but is preferably made of non-magnetic material such as, for example, a polymer, cellulose, ceramic, non-ferrous metal and/or other natural or man made material. In addition, when the magnet of attachment device 16 includes a plurality of connected magnets as described previously, housing 30 can flexibly connect the magnets together into a single assembly. The configurations of housing 30 in this embodiment can include a flexible plate or layer, a cup and or one or more lines such as a fishing line, for example, that connect the magnets in a flexible relationship.

In operation as shown in FIG. 2, vehicle 6 is initially positioned on a surface 2 with the potential for movement in a first direction as shown by an Arrow-A and a second direction as shown by an Arrow-B. It is understood that while Arrow-A is shown as the forward direction of vehicle 6 and Arrow-B is shown as the rear direction of vehicle 6, these identifications are arbitrary and chock assembly 10 can be employed to block the undesired movement of vehicle 6 in either the direction of Arrow-A or Arrow-B.

Vehicle 6 is in a securely parked position and wheel chock assembly 10 is an additional safety device to block any undesired movement of vehicle 6 in the direction of arrow-B. As defined herein, securely parking vehicle 6 includes, for example, placing the vehicle's automatic transmission in park or for a manual transmission vehicle placing the transmission in a forward gear. In addition, the emergency brake of vehicle 6 should is also applied.

Wheel chock assembly 10 is shown in a first position that includes wheel chock 12 located on surface 2 blocking vehicle 6 from movement in one direction, attachment device 16 is connected to vehicle 6 and tether 14 extends between and is connected to wheel chock 12 and attachment device 16. In this one idealized example, surface 2 slopes downward in the direction of Arrow-B, but it is understood that surface 2 can be level or slope in any direction. Base side 18 of wheel chock 12 is positioned to engage the down slope side of surface 2 relative to wheel 4 and engage ramp side 20 of wheel chock 12 with the down slope side or down slope portion of the circumference of wheel 4.

Once the user of wheel chock assembly 10 engages wheel chock 12 with wheel 4 and surface 2, the user extends tether 14 and connects attachment device 16 to vehicle 6. In this example, the user engages wheel chock 12 and extends tether 14 to connect attachment device 16 from beside the vehicle in a few quick seconds. The user of wheel chock assembly 10 does not need to step behind vehicle 6 to position wheel chock 12 or attachment device 16. In one preferred embodiment, first end portion of tether 14 can be selectively connected to either backside 22 or one of and preferably the outer side 24 of wheel chock 12.

The flexibility of tether 14 accommodates the positioning of attachment device 16 at a preferred location of magnetic material on vehicle 6. In one preferred embodiment, attachment device 16 is positioned on the body of vehicle 6 in proximity to wheel 4 and fixed in position on vehicle 6 by the magnetic force between attachment device 16 and the body. It is understood, however, that attachment device 16 can be connected to any magnetic portion of vehicle 6 within the range of the length of tether 14. This can include a portion of the frame and/or body of vehicle 6. Attachment device 16 can also include a release that facilitates the disconnection of attachment device 16 from vehicle 6. The release can include a tab on attachment device 16 to facilitate pulling an initial edge away from vehicle 6 or a separate insert, as another example, that can be slid between attachment device 16 and vehicle 6 to break the magnetic bond.

The preferred length of tether 14 of between approximately three (3) and four (4) feet is sufficient in most applications to extend attachment mechanism 16 from chock 12 to a desired location on vehicle 6. One preferred location of attachment device 16 is approximately above and at least slightly to the rear of wheel 4. Vehicle 6 as defined herein can include the frame and/or body of vehicle 6 that functions as an external source of magnetism for the magnetic connection of attachment mechanism 16. As shown in this one example, layer 26 on the magnetic of attachment device 16 interfaces with the rear quarter panel of vehicle 6 which is also an external source of magnetism.

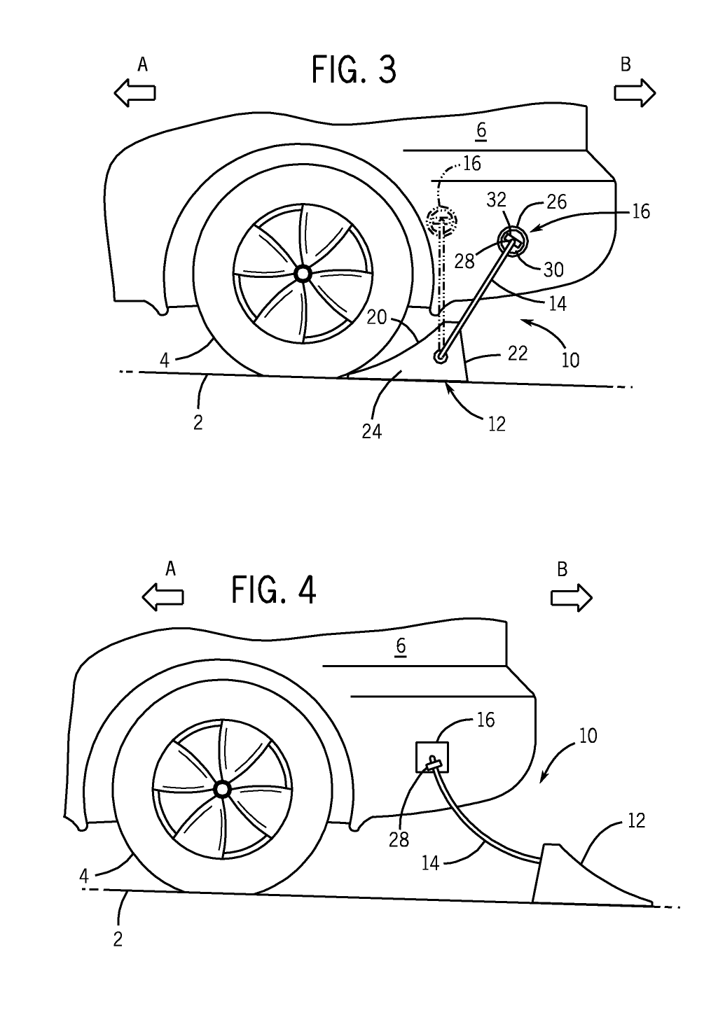

Referring now to FIG. 3, in one preferred embodiment, tether 14 is a bar or rod that connects wheel chock 12 and attachment device 16. Tether 14 in this embodiment can be rigid, flexible and/or include other features such as an adjustable length. The adjustable length of tether 14 can use any known mechanical means such as, for example, a telescoped or staggered construction to adjust the length of tether 14. In the rigid tether 14 embodiment, attachment device 16 preferably includes an adjustable or flexible connection to tether 14 that accommodates the movement of tether 14 relative to wheel chock 12 and/or attachment device 16. The flexible connections can include for example a ball and socket, interconnected rings, etc. that accommodate rotational movement of rigid tether 14 relative attachment device 16. A rigid tether 14 can add an additional element of safety to wheel chock assembly 14 by providing resistance to the displacement of chock 12 from its position behind wheel 4 or in the direction of Arrow-B. Similarly, a biased flexible semi-rigid tether 14 can provide a bias to wheel chock 12 positioned against wheel 4 and surface 2.

In this one preferred embodiment, attachment device 16 is a suction cup type device that uses a suction force to connect to vehicle 26. Attachment device 16 that includes a suction cup has the advantage that it can securely connect to any non-porous material on vehicle 6 such as glass, polymers, non-magnetic metals, fiberglass and/or composite materials.

Attachment device 16 in this embodiment includes layer 26, connecter 28 for tether 14 and housing 30. Layer 26 is an outer sealing edge in this one preferred embodiment that has sufficient flexibility to accommodate variations in the shape of the body of vehicle 6. Connector 28 attaches the second end portion of tether 14 as described previously to attachment device 16. Attachment device 16 connects to vehicle 6 using a firm push against housing 30 to compress the flexible resilient layer 26 to make the suction connection on vehicle 6. Attachment device 16 can further include a mechanically assisted suction pump that uses a plunger or lever, for example, to assist the connection of attachment device 16 to vehicle. Attachment device 16 that includes a suction cup can also include a release for the disconnecting of attachment device 16.

As shown in FIG. 4, wheel chock assembly 10 is in a second position with wheel 4 disengaged from wheel chock 12 by the movement of vehicle 6 in the direction of Arrow-A. Disengaged wheel chock 12 is being pulled beside vehicle 6. Attachment device 16, whether connected by magnetism or by suction, has sufficient bond strength to stay affixed to the vehicle while tether 14 and wheel chock 12 are dragged beside the vehicle. At any point as vehicle 6 moves in the first direction or in the direction of Arrow-A, vehicle 6 can be stopped, attachment device 16 disconnected from vehicle 6 and wheel chock assembly 10 conveniently stored.

In one preferred embodiment of wheel chock assembly 10, attachment device 16 is a flexible magnetic strip or panel that is removably positionable on vehicle 6. The second end portion of tether 14 can connect directly to attachment device 16 or to an optional housing 30. Connector 28 fastens the second end portion of tether to attachment device 16 using an adhesive or a connector bonded to the outer surface of the magnetic panel. This configuration of attachment device 16 has the advantage that it can be a lighter weight, readily adapt to body shapes and still maintain a large surface area connection with vehicle 6. The magnetic panel can also be used to convey slogans, ornamental designs and/or advertising.

In the preceding specification, the present disclosure has been described with reference to specific exemplary embodiments thereof. It will be evident, however, that various modifications, combinations and changes may be made thereto without departing from the broader spirit and scope of the invention as set forth in the claims that follow. For example, it is understood that wheel chock assembly 10 can be used with any kind of wheeled vehicle 6. In addition, though the present invention is described in terms of a series of embodiments, each embodiment of the present invention can combine one or more novel features of the other embodiments. The specification and drawings are accordingly to be regarded in an illustrative manner rather than a restrictive sense.

What is claimed is:

1. A wheel chock assembly that comprises:
a wheel chock that includes an inclined ramp that connects to an opposed backside, a base that connects the backside and the ramp side, two opposing sides that connect to the ramp, backside and base, the ramp side adapted to engage a tire of a vehicle and block the movement of the wheel of the vehicle in a first direction;
an attachment device adapted to connect to the vehicle;
a tether that connects the wheel chock and the attachment device;

2. The wheel chock assembly of claim 1, wherein the tether is flexible.

3. The wheel chock assembly of claim 1, wherein the tether is biased, the attachment device and tether positionable so as to bias the position of the wheel chock.

4. The wheel chock assembly of claim 1, wherein the tether is approximately rigid, the tether flexibly connected to the attachment device.

5. The wheel chock assembly of claim 1, wherein the attachment device includes a magnet, the magnet defines a face, the face adapted to connect to the vehicle.

6. The wheel chock assembly of claim 1, wherein the attachment device includes a magnet, the magnet connected to a housing, the magnet defining a face that extends from the housing, the face adapted to connect to the vehicle.

7. The wheel chock assembly of claim 5, wherein the face of the magnet includes a layer.

8. The wheel chock assembly of claim 1, wherein the attachment device is a flexible magnetic sheet.

9. The wheel chock assembly of claim 1, wherein the attachment device is a suction cup.

10. The wheel chock assembly of claim 9, wherein the suction cup includes an actuator that selectively applies and removes the suction connection to the vehicle.

11. The wheel chock assembly of claim 9, wherein the suction cup includes a handle.

12. A wheel chock assembly that comprises:
a wheel chock that includes an inclined ramp that connects to an opposed backside, a base that connects the backside and the ramp side, two opposing sides that connect to the ramp, backside and base, the ramp side adapted to interface with a portion of a circumference of a wheel of a vehicle and block the movement of the vehicle in a first direction;
an attachment device adapted to connect to the vehicle;
a tether that connects the wheel chock and the attachment device;
a first position that includes the wheel chock engaged with the wheel of the vehicle and blocking the movement of the vehicle in a first direction, the tether connecting with the attachment device and wheel chock, the attachment device connected to the vehicle;
a second position that includes the vehicle moving in a second direction opposed to the first direction, the movement in the second direction disengaging the wheel from the wheel chock, the attachment device connected to the vehicle and the attachment device and tether pulling the wheel chock beside the vehicle.

13. The wheel chock apparatus of claim 12, wherein the attachment device includes a magnet and the attachment device adapted to connect to a magnetic portion of the vehicle.

14. The wheel chock apparatus of claim 12, wherein the attachment device includes a suction cup and the attachment device adapted to connect to the vehicle.

15. A method of removing a wheel chock from a vehicle on a surface comprising providing a wheel chock assembly that includes a wheel chock, tether and an attachment device, the tether connecting the wheel chock and the attachment device, engaging the wheel chock between the surface and a wheel of the vehicle, the wheel chock blocking the movement of the vehicle in a first direction, connecting the attachment device to the vehicle, moving the vehicle in a second direction opposing the first direction, the moving of the vehicle in the second direction disengaging the wheel from the wheel chock, the attachment device connected to the vehicle and moving with the vehicle, the attachment device and tether pulling the wheel chock with the moving vehicle.

16. The method of removing of claim 15 wherein the step of connecting the attachment device further includes positioning the tether between the attachment device and the wheel chock to bias the wheel chock to engage the surface and the wheel.

17. The method of removing of claim 15 wherein the step of connecting the attachment device further includes connecting the attachment device to the vehicle such that the attachment device and an approximately rigid tether fix the position of the wheel chock engaging the surface and the wheel.

18. The method of removing of claim 15 wherein, the step of connecting the attachment device includes connecting a magnet of the attachment device to connect to a magnetic portion of the vehicle.

19. The method of removing of claim 15, wherein the step of connecting the attachment device includes using a suction cup of the attachment device to connect to the vehicle.

20. The method of removing of claim 15, wherein the step of pulling includes pulling the wheel chock beside the vehicle.
